(19) United States
(12) Patent Application Publication
(10) Pub. No.: US 2013/0344194 A1
(43) Pub. Date: Dec. 26, 2013

(54) COMPOSITE FLOUR AND PROTEIN-ENERGY FOODS CONTAINING THE SAME

(71) Applicant: C. Fordham von Reyn, Fairlee, VT (US)

(72) Inventor: C. Fordham von Reyn, Fairlee, VT (US)

(21) Appl. No.: 13/879,064

(22) PCT Filed: Oct. 6, 2011
(86) PCT No.: PCT/US11/55012

§ 371 Date: Apr. 12, 2013

Related U.S. Application Data
(60) Provisional application No. 61/392,550, filed on Oct. 13, 2010.

(51) Int. Cl. A23L 1/10

(52) U.S. Cl. CPC A23L 1/1041
USPC 426/2; 426/622; 426/549; 426/560; 426/619

(57) ABSTRACT

The present invention is a nutritious composite flour composed of maize, flour, flour, and millet flours and food products containing the same for use in providing protein and energy to a subject.

This invention was made with government support under contract number 1RO1 HD057614 awarded by the National Institutes of Health. The government has certain rights in the invention.

### INTRODUCTION

This patent application claims the benefit of priority from U.S. Provisional Application Ser. No. 61/392,550 filed Oct. 13, 2010, the content of which is incorporated herein by reference in its entirety.

### BACKGROUND OF THE INVENTION

An estimated 17 million women aged 15-49 years of age worldwide are HIV-infected (HIV-positive), 77% of whom reside in sub-Saharan Africa (UNAIDS/WHO. AIDS epidemic update. Joint United Nations Programme on HIV/AIDS. Geneva, Switzerland: UNAIDS, 2002:1-42; UNAIDS, JUNPoHA. 2004 report on the global HIV/AIDS epidemic: 4th global report. Geneva, Switzerland: UNAIDS, 2004. WHO. New data on the prevention of mother-to-child transmission of HIV and their policy implications: conclusions and recommendations. Geneva, Switzerland: Technical Consultation on behalf of the UNFPA/WHO/UNAIDS Inter-Agency Task Team on Mother-to-Child Transmission of HIV, 2001). In many areas of southern Africa, the prevalence of HIV is ≧40% in women attending antenatal clinics. Despite concerns about the risk of transmitting HIV to infants via breastfeeding (WHO. New data on the prevention of mother-to-child transmission of HIV and their policy implications: conclusions and recommendations. Geneva, Switzerland: Technical Consultation on behalf of the UNFPA/WHO/UNAIDS Inter-Agency Task Team on Mother-to-Child Transmission of HIV, 2001) and the suggestion that breastfeeding may have an adverse effect on the nutritional status of HIV-positive women (Nduati, et al. (2001) Lancet 357:1651-5), the use of replacement milks for infant feeding is often unacceptable, unaffordable, or unsafe (Coutsoudis et al. (2002) Health Policy Plan 17:154-60; Papathakis & Rollins (2004) Bull. World Health Organ. 82:164-71; Latham & Preble (2000) BMJ 320:1656-60; Phadke, et al. (2003) J. Nutr. 133:3153-7). Because breastfeeding remains the most common form of infant feeding for both HIV-positive and HIV-uninfected (HIV-negative) mothers in this setting, proper nutrition for the mother is of importance to the overall health and well being of mothers and their infant.

In this respect, porridges and Ready-to-Use Therapeutic Food (RUTFs) such as PLUMPY'NUT® have been studied in women with HIV and malnourished populations. Moreover, WO/2005/096837 describes a RUTF product or nutritional supplement that is free of peanuts and animal-derived products for use in the treatment of gut-associated malnourishment, HIV/AIDS, cancer-cachexia, and post-operative conditions. This RUTF is composed of a mixture of at least one ground, roasted cereal (e.g., oats, maize, quinoa, barley, wheat, rye, sorghum, millet, teff, or rice) and at least one ground, roasted legume (e.g., chick pea, soybean, lentil, split pea, haricot bean, mung bean, fava bean, pigeon bean, or kidney bean) or cooked leguminous protein extract for use.

Additional food products are described in WO 2008/036646, which are composed of a non-wheat cereal storage protein (e.g., maize, sorghum, millet, rice, oat and mixtures thereof) and a co-protein that stabilizes the structure of the storage protein, as well as non-wheat proteins such as soy protein and a starch or cereal flour from corn, rice, sorghum, or edible bean starch.

Khetarpaul, et al. (((2009) Br. Food J. 111:554-564) further describe a composite flour composed of wheat flour mixed with salt-treated partially defatted soy dhal (i.e., soy flour), sorghum, rice, maize and pearl millet (50:10:10:10:10:10), which exhibits a significant increase in moisture and protein content when compared to unprocessed composite flour and wheat flour.

### SUMMARY OF THE INVENTION

The present invention features a composite flour composition composed of maize flour, soybean flour, sorghum flour, and millet flour, wherein the maize flour, soybean flour, sorghum flour, and millet flour are at a ratio of 4:2:1:1.

The present invention is also a biscuit or bar product containing the composite flour, milk, soy protein, sugar, and oil, as well as a porridge product containing the composite flour, full cream milk, and sugar, and methods for using the same to provide a protein and energy source.

### DETAILED DESCRIPTION OF THE INVENTION

The present invention features a composite flour composition and biscuit or bar and porridge products containing the same. For the purposes of the present invention, a composite flour is a combination of different flours that is both nutritious and functional, e.g., providing a source of protein and/or energy. In this respect, the instant composite flour finds use in the preparation of various food products and in providing a protein and/or energy source.

The composite flour of the invention is composed of maize (corn) flour, soybean flour, sorghum flour, and millet flour. In some embodiments, the composite flour only includes maize flour, soybean flour, sorghum flour, and millet flour. In other embodiments, the composite flour further includes one or more of oat flour, quinoa flour, barley flour, rye flour, triticale flour, cassava flour or rice flour. Whether used alone or in combination with other flours, particular embodiments feature the use of maize, soybean, sorghum, and millet flours at a ratio of 4:2:1:1.

The flours of the composite flour of the invention can be produced by any conventional milling or grinding process. For maize (Zea mays), the seed can be ground into a fine flour or meal. Maize meal is produced by grinding the whole grain, whereas a fine flour is obtained from milling the endosperm of the maize grain after the germ and outer layers are removed. As with all cereals, most micronutrients are concentrated in the outer layers of the grain; thus removing these layers in the milling process results in the loss of most vitamins and minerals. These losses, however, can be replaced through enrichment or fortification without affecting the quality or acceptability of foods made from maize flour. Whole maize is a good source of thiamin, pyridoxine and phosphorus, and a fair source of riboflavin, niacin, folate, biotin, iron and zinc. However, these nutrients may be lost during milling. Micronutrients not present in significant amounts include vitamins A and E and calcium. All of the above nutrients can be easily added to maize flour during the milling process. The concentration of vitamins and minerals to be added can be calculated based on nutritional requirements and consumption patterns. For example, maize flour in Venezuela is typically fortified with a vitamin-mineral premix containing vitamin A, thiamin, riboflavin, niacin, and iron. Similarly, maize flour in Zimbabwe and Namibia is typically fortified with a vitamin-mineral premix containing vitamin A, thiamin, riboflavin, niacin, folate, pyridoxine and iron.

Soybean flour is typically produced by milling soybean flakes that have either retained the soybean's naturally occurring oil to make full fat flour or solvent-extracted the oil to make de-fatted flour. To make low-fat soybean flour, a mechanical extractor process removes about 75% of the oil. Alternatively, oil can be extracted from soybean flour using high pressure carbon dioxide or other liquids. Full fat and de-fatted flour can be provided in enzyme active or toasted forms and in different particle sizes from ultra fine powders to more coarse soy grits. Further processing soybean flour produces dry textured nuggets called textured soybean flour. In relation to wheat flour, which contains 12-16% protein, full-fat (18%-20% fat) soybean flour contains ˜40% protein, low-fat (4.5%-9% fat) soybean flour contains 52% protein, and defatted (less than 1% fat) soybean flour contains ˜50-55% protein (Mustakas (1971) J. Am. Oil Chem. Soc. 48:815-819; Smith & Circle (1972) Soybeans: Chemistry and Technology. The AVI Publishing Company. Page 442). For use in the instant invention, some embodiments include the use of defatted soybean flour, while other embodiments include the use of full-fat soybean flour or low-fat soybean flour.

Sorghums are grains of the genus Sorghum and include S. bicolor, S. propinquum and S. halepense (Johnson grass). The processing of sorghum typically involves milling the grain by debranning and reducing the endosperm into a meal or flour. Sorghum can be milled to flour of varying extraction rates (60%, 80%, 100%), and subsequently pin-milled at different speeds (no pin-milling, low-speed, and high-speed) to create flours of both variable composition and particle size. Sorghum flour is of use in the instant composite flour as it contains a protein content of approximately 14%-16% (Awadalkareem, et al. (2008) Pakistan J. Nutr. 7:475-479; Khalil, et al. (1984) Plant Foods Hum. Nutr. 34:141-150), a fat content of 4%-5% and a fiber content of 2.3%-2.9% (Khalil, et al. (1984) supra).

Millet, which includes common millet or proso (Panicum miliaceum), Foxtail or Italian millet (Setana italica), barnyard millet (Echinochloa frumentacea) and pearl millet (Pennisetum glaucum), can be prepared into flour using any conventional method. The protein content in millet is very close to that of wheat (˜11%) and millet is rich in B vitamins, calcium, iron, potassium, magnesium, and zinc.

The nutritious composite flour of the invention can be used in the preparation of various nutritional foods or nutritional food products including, but not limited to, health bars, porridge, or bakery products such as biscuits, bars, cookies, muffins, breads, cereals, noodles, crackers, snack foods or other similar forms of foods. In particular embodiments, the composite flour of the invention is used in the preparation of a ready-to-use biscuit/bar or porridge product. Exemplary formulations for biscuit/bar or porridge products are described in Examples 2 and 3.

A biscuit or bar of the invention is composed of the instant composite flour containing maize, soybean, sorghum, and millet flours at a ratio of 4:2:1:1, in combination with milk, soybean protein, sugar, and oil. The composite flour content of the biscuit/bar can range from about 20% to 40% of the total weight of the biscuit/bar composition. In particular embodiments, the composite flour content is about 30-35% by weight of the total weight of the biscuit/bar composition.

Milk includes whole milk (full fat), low fat milk, skim milk, etc. in liquid or powdered form obtained from any suitable animal including, but not limited to, cows, sheep, yaks, water buffalo, camels, and goats. The milk content of the biscuit/bar can range from about 10% to 20% of the total weight of the biscuit/bar composition. In particular embodiments, the milk content is about 15-17% by weight of the total weight of the biscuit/bar composition.

The soybean protein component of the instant biscuit/bar is intended to mean a product of soybean origin in which the proteins have been concentrated. Soy proteins are obtained by removing a portion of the carbohydrates from dehulled and defatted soybeans. There are different soy protein production methods including alcohol extraction, which removes soy isoflavones, and water extraction, which removes the sugars but retains the isoflavones in the final product. Soybean protein products of the invention can be prepared by any suitable process and desirably retain at least 50% crude protein, as related to the dry matter. The soybean protein content of the biscuit/bar can range from about 10% to 20% of the total weight of the biscuit/bar composition. In particular embodiments, the soybean protein content is about 15-17% by weight of the total weight of the biscuit/bar composition.

Sugar includes any suitable mono- or disaccharide, honey, molasses, or artificial sweetener. In certain embodiments, the sugar of the instant biscuit/bar is sucrose, since it is generally inexpensive and readily available. The sugar content of the biscuit/bar can range from about 10% to 20% of the total weight of the biscuit/bar composition. In particular embodiments, the sugar content is about 15-17% by weight of the total weight of the biscuit/bar composition.

The oil component of the instant biscuit/bar is desirably a vegetable oil, such as sunflower oil, palm oil, coconut oil, palm kernel oil, or rapeseed oil. The oil content of the biscuit/bar can range from about 10% to 20% of the total weight of the biscuit composition. In particular embodiments, the oil content is about 15-17% by weight of the total weight of the biscuit/bar composition.

A porridge of the invention is composed of the instant composite flour containing maize, soybean, sorghum, and millet flours at a ratio of 4:2:1:1, in combination with milk and sugar. The composite flour content of the porridge can range from about 30% to 50% of the total weight of the porridge composition. In particular embodiments, the composite flour content is about 40% by weight of the total weight of the porridge composition.

To provide both protein and fat, the milk of the instant porridge is desirably whole milk or full cream milk, i.e., milk that has had its cream blended in and homogenized. This is distinct from milk that has been separated from its cream, e.g., low-fat, skim, reduced fat, nonfat, 1%, or 2% milk. Whole milk from cows is about 3.5%-3.8% milk fat, whereas milk from goat is about 4.1% milk fat. The milk of the instant porridge can be in dry or liquid form depending on its intended use. For example, for ease in shipping and distribution, the milk can be in powder form, and the porridge can be rehydrated at the time of use. The milk content of the instant porridge can range from about 30% to 50% of the total weight of the porridge composition. In particular embodiments, the milk content is about 40% by weight of the total weight of the porridge composition.

The sugar component of the instant porridge can be any one of the sugars described for use in the biscuit of the present invention and is, in particular embodiments, sucrose. The sugar content of the instant porridge can range from about 10% to 30% of the total weight of the porridge composition. In particular embodiments, the sugar content is about 20% by weight of the total weight of the porridge composition.

The composite flour or food products of the invention can also include one or more supplementary micronutrients such as, for example, vitamins, soluble or insoluble mineral salts and mixtures thereof. Vitamins include, e.g., one or more of Vitamin A (retinol), Vitamin D (calciferol), Vitamin E (a-tocopherol), Vitamin C (ascorbic acid), Vitamin B1 (thiamine), Vitamin B2 (riboflavin), Vitamin B6 (pyridoxine), Vitamin B12 (cyanobalamin), Vitamin B9, Vitamin B5 (pantothenic acid), Vitamin B8 and Vitamin K. Minerals include, but are not limited to, calcium, iron and zinc, whereas mineral salts include calcium carbonate, zinc oxide, copper sulfate, potassium chloride, magnesium oxide or iron salts. The composite flour or food products may also include enzymes. By way of illustration, a food product of the instant invention can be supplemented with 80 mg vitamin C, 15 mg vitamin E, 1.2 mg thiamine, 1.2 mg riboflavin, 15 mg niacin, 1.3 mg vitamin B6, 0.4 mg folic acid and 2.4 mg vitamin B12.

Protein-energy malnutrition is the leading cause of death in children in developing countries. It develops in children and adults whose consumption of protein and energy (measured by calories) is insufficient to satisfy the body's nutritional needs. Primary protein-energy malnutrition results from a diet that lacks sufficient sources of protein and/or energy, whereas secondary protein-energy malnutrition is more commonly observed as a complication of AIDS and other illnesses, e.g., tuberculosis, that impair the body's ability to absorb or use nutrients or compensate for nutrient losses. Breastfeeding a baby for at least six months is considered the best way to prevent early-childhood malnutrition. However, breastfeeding can deplete the mother of protein and/or energy thereby reducing her overall health and well-being. In this respect, administration of a food product of the invention (e.g., a biscuit/bar or porridge) provides both a protein and energy source to a subject in need of the same thereby preventing or ameliorating protein-energy malnutrition. Subjects benefiting from the instant compositions include men, women and children of developing countries, subjects with a protein deficiency, and particularly breastfeeding women with a disease such as HIV or tuberculosis. A subject with a protein deficiency is intended to include a subject with depleted levels of protein, a subject in need of additional protein to achieve enhanced growth and development, or a subject exhibiting a disruption in protein metabolism due to a disease or condition (e.g., after surgery).

In particular embodiments, the bar/biscuit of the invention finds application as an adjunct to the antibiotic treatment of tuberculosis. The association between poor nutritional status and tuberculosis is well-described in the literature (Cegielski & McMurray (2004) Int. J. Tuberc. Lung Dis. 8:286-98; Niyongabo, et al. (1999) Nutrition 15:289-93; Venkatesh, et al. (2005) Int. J. Tuberc. Lung Dis. 9:1105-11). When HIV infection is also present, the relationship between tuberculosis and poor nutritional status persists (van Lettow, et al. (2003) Nutr. Rev. 61:81-90) with, in some cases, lower BMIs observed among HIV-infected individuals with tuberculosis than among HIV-uninfected individuals with tuberculosis (Niyongabo, et al. (1999) supra). Furthermore, the severity of disease in pulmonary tuberculosis has been shown to correlate with the severity of malnutrition in both HIV-infected and HIV-uninfected adults (van Lettow, et al. (2004) Int. J. Tuberc. Lung Dis. 8:211-7). Treatment of active tuberculosis and reversal of associated malnutrition has been associated with restoration of T cell immunity to tuberculosis and reversal of false negative TST results, and protein malnutrition has been specifically shown to suppress tuberculosis immunity (Pelly, et al. (2005) Int. J. Tuberc. Lung Dis. 9:977-84; Griffin, et al. (1983) Clin. Pharm. 2:432-5; Huebner, et al. (1993) Clin. Infect. Dis. 17:968-975). Accordingly, the “Dar-bar” and “Dar-kaki” of the instant invention are of particular use in the treatment of subjects with tuberculosis, with or without HIV, as these products are formulated to provide more rapid resolution of the malnutrition associated with active tuberculosis and to improve the overall outcome of tuberculosis treatment.

Amounts of the instant biscuit, bar, or porridge product consumed can vary depending on the subject (e.g., adult versus child), as well as the intended use (e.g., to ameliorate a disease or condition versus maintenance of protein-energy levels). The amount selected can be based upon routine clinical trials or dosing of similar types of food or food products.

The invention is described in greater detail by the following non-limiting examples.

### Example 1

### Nutritious Composite Flour

An exemplary formula for a nutritious composite flour (Lishe flour) of the invention is provided in Table 1.

TABLE 1

| Flour | Grams | Kcal | Protein (g) | Fat (g) |
|---|---|---|---|---|
| Maize | 200 | 724 | 16.2 | 7.2 |
| Soybean | 100 | 415 | 36.5 | 20 |
| Sorghum | 50 | 169 | 5.5 | 1.5 |
| Millet | 50 | 164 | 3.3 | 0.6 |
| Total | 400 | 1472 | 61.5 | 29.3 |

On a per 100 g basis, this flour provides 368 Kcal, 15.4 grams of protein and 7.3 grams of fat.

### Example 2

Porridge Containing Nutritious Composite Flour

An exemplary formula for a porridge (“Dar-uji”) containing the nutritious composite flour of the invention is provided in Table 2.

TABLE 2

| Ingredient | Grams | Kcal | Protein (g) | Fat (g) |
|---|---|---|---|---|
| Our Lishe flour | 100 | 368 | 15.4 | 7.3 |
| Full Cream, Dried Milk | 100 | 496 | 26.1 | 26.7 |
| Sugar | 50 | 198 | — | — |
| Total | 250 | 1062 | 41.5 | 34 |

The porridge is prepared in 900 mL with 300 mL/serving. Each serving provides 354 Kcal, 13.8 grams of protein (˜15.6% of the total Kcal) and 11.3 grams of fat (˜11.3% of the total Kcal).

### Example 3

### Biscuit/Bar Containing Nutritious Composite Flour

An exemplary formula for a ready-to-use biscuit (“Darkaki”) or bar (“Dar-bar”) containing the nutritious composite flour of the invention is provided in Table 3.

TABLE 3

| Ingredient | Grams | Kcal | Protein (g) | Fat (g) |
|---|---|---|---|---|
| Lishe flour | 100 | 368 | 15.4 | 7.3 |
| Milk | 50 | 248 | 13 | 13.3 |
| Soy protein | 50 | 190 | 23 | 9 |
| Sugar | 50 | 198 | — | — |
| Oil | 50 | 431 | — | 50 |
| Total | 300 | 1435 | 51.4 | 79.6 |

When prepared in biscuit form, the formula makes 12 biscuits (245 grams) with each biscuit weighing 20.4 grams and providing 119 Kcal, 4.3 grams of protein (17.2 Kcal=14.4% of the total Kcal) and 6.6 grams of fat (59.4 Kcal=49.9% of the total Kcal).

A randomized clinical trial is conducted to compare the biscuits/bars and porridge in the same two groups of women (each with a corresponding control group that does not receive the supplements) to demonstrate that there are beneficial health effects to receiving the nutritious composite flour.

What is claimed is:

1. A composite flour composition comprising maize flour, soybean flour, sorghum flour, and millet flour, wherein the maize flour, soybean flour, sorghum flour, and millet flour are at a ratio of 4:2:1:1.

2. A biscuit or bar product comprising the composite flour composition of claim 1, milk, soy protein, sugar, and oil.

3. A method for providing a protein and energy source comprising administering the biscuit or bar product of claim 2 to a subject in need thereof thereby providing a protein and energy source to the subject.

4. A porridge product comprising the composite flour composition of claim 1, full cream milk, and sugar.

5. A method for providing a protein and energy source comprising administering the porridge product of claim 4 to a subject in need thereof thereby providing a protein and energy source to the subject.
